(19) United States
(12) Patent Application Publication
(10) Pub. No.: US 2024/0374000 A1
(43) Pub. Date: Nov. 14, 2024

(54) LEATHER WALLETS

(71) Applicant: The Ridge Wallet LLC, Santa Monica, CA (US)

(72) Inventors: Daniel Kane, Agoura Hills, CA (US); Austin Pearce Dutra, Santa Monica, CA (US)

(21) Appl. No.: 18/661,332

(22) Filed: May 10, 2024

Related U.S. Application Data
(60) Provisional application No. 63/501,977, filed on May 12, 2023.

(51) Int. Cl. A45C 1/06; B32B 5/02; B32B 9/02; B32B 9/04

(52) U.S. Cl. CPC A45C 1/06; B32B 5/02; B32B 9/025; B32B 9/047; A45C 2001/062; A45C 2001/067; B32B 2250/02; B32B 2255/02; B32B 2255/26

(57) ABSTRACT

Described herein are leather wallets including one or more multi-layer plates. The multi-layer plate(s) can be in the form of a sandwich construction. In some embodiments, the multi-layer plate can comprise a substrate layer, a polymeric layer, and/or a material layer. In some embodiments, the material layer comprises a soft material like leather, synthetic leather, or the like. The disclosure herein improves on the prior art, in which wallet products using multi-layer plates involved the use of only hard (e.g., non-leather) materials.

### CROSS REFERENCE TO RELATED APPLICATION

This application is a non-provisional of, and claims the benefit of and priority to, U.S. Provisional Application No. 63/501,977, filed on May 12, 2023.

### FIELD

Described herein are wallets, specifically leather wallets.

### SUMMARY

Described herein are wallets which, in various embodiments, include a multi-layer plate comprising a substrate layer, a polymeric layer, and a material layer including a soft material, bonded to the substrate layer by the polymeric layer. In certain embodiments, the material layer is less than 1 mm thick, although other thicknesses are contemplated and disclosed herein.

In some embodiments, the substrate layer includes fiberglass.

In other embodiments, the polymeric layer is an adhesive.

In some embodiments, the soft material is leather. The leather can be natural leather, bonded leather, synthetic leather, or the like.

In other embodiments, the substrate layer includes a rigid plate. The rigid plate includes a top edge, a bottom edge, a first side edge, and a second side edge.

In some embodiments, the material layer extends substantially to the top edge of the rigid plate. In other embodiments, the material layer extends substantially to the bottom edge of the rigid plate.

In some embodiments, the material layer extends substantially to the first side edge of the rigid plate. In other embodiments, the material layer extends substantially to the second side edge of the rigid plate.

In some embodiments, one or more of the rigid plate, the polymeric layer, and/or the soft material includes a channel configured to accommodate an elastic band. In other embodiments, one or more of the rigid plate, the polymeric layer, and/or the soft material includes a channel configured to accommodate a money clip.

### BRIEF DESCRIPTION OF THE DRAWINGS

FIG. 1 illustrates a front view of a leather wallet as described herein.

FIG. 2 illustrates a rear view of the leather wallet shown in FIG. 1.

FIG. 3A illustrates a cross-sectional view of the leather wallet shown in FIG. 1 along the arrows labeled 3A. FIG. 3B illustrates a focused view of the circled portion labeled 3B in FIG. 3A.

FIG. 4 illustrates a front, perspective view of the leather wallet shown in FIG. 1.

FIG. 5 illustrates a front view of a leather wallet described herein.

FIG. 6A illustrates a cross-sectional view of the leather wallet shown in FIG. 5 along the arrows labeled 6A. FIG. 6B illustrates a focused view of the circled portion labeled 6B in FIG. 6A.

### DETAILED DESCRIPTION

The present disclosure incorporates U.S. Pat. No. 10,791,808 herein by reference in its entirety.

Described herein are leather wallets including one or more multi-layer plates. The multi-layer plate(s) can be in the form of a sandwich construction. In some embodiments, the multi-layer plate can comprise a substrate layer, a polymeric layer, and/or a material layer. In certain embodiments, the multi-layer plate is only used on one side of a two-sided wallet; the other side, in such embodiments, may be a single layer plate whose openings are formed by boring or otherwise removing material.

Currently, leather wallets in the marketplace are poorly manufactured. For example, after just a few uses the edges of the leather start to fray and/or peel. The marketplace's solution is to use thick leather pieces in an attempt to prevent fraying and/or peeling. This creates a bulkier wallet departing from a compact and slim wallet. Also, most leather wallets in the market today include a leather exterior that is not flush with the frame of the wallet. The leather wallets described herein provide a solution to prevent fraying and/or peeling edges of leather while maintaining an overall aesthetic look that has come to be expected by consumers of such products. The disclosed leather wallets also advantageously provide a leather aesthetic look but do not catch or snag on a user's pockets or bags when being removed for access.

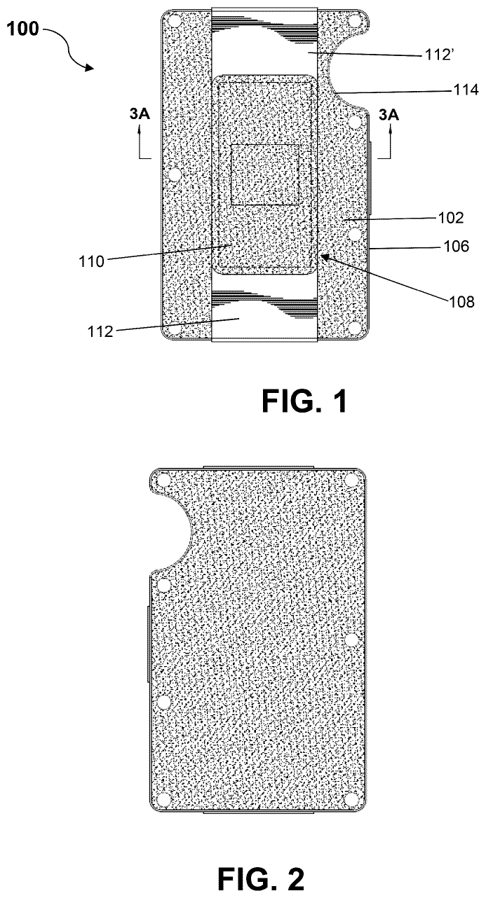

FIG. 1 illustrates leather wallet 100 described herein. Leather wallet 100 comprises substrate layer 106, a polymeric layer (not shown in FIG. 1), and material layer 102.

Substrate layer 106 can include, but is not limited to, fiberglass, metal(s), stainless steel, plastic, or carbon fiber. Metals usable in layer 106 can include, but are not limited to, steel, carbon steel, alloy steel, stainless steel, iron, wrought iron, aluminum, copper, brass, bronze, cobalt, magnesium, nickel, tin, zinc, titanium, tungsten, silicon, silver, and gold. In some embodiments, the substrate layer can include a combination of metals. In other embodiments, the substrate layer is fiberglass.

The polymeric layer can be (or can include) an adhesive. Adhesives for use on or with the polymeric layer can include, but are not limited to, a wet adhesive, a contact adhesive, a reactive adhesive, a single-component reactive adhesive, a two-component reactive adhesive, a hot melt adhesive, a pressure-sensitive adhesive, an epoxy adhesive, a polyurethane adhesive, a polyimide adhesive, a paste, a liquid, a film, a pellet, a hot melt, or glue. The adhesive may be integral with, or applied to, a polymeric layer in certain embodiments.

Material layer 102 can include a soft material. The soft material usable for material layer 102 can be, but is not limited to, leather, leather cloth, leatherette, micro suede, microfiber, mesh, fabric, vinyl, canvas, nylon, silicone, or the like. In some embodiments, the soft material is leather. The leather can be, but is not limited to, natural leather, bonded leather, synthetic leather, the like, or a combination thereof. In some embodiments, the material layer does not include soft material, but rather is comprised of hard material. In some embodiments, the material layer is wood.

As illustrated in FIG. 1, in some embodiments, material layer 102 can be bonded to substrate layer 106 by the polymeric layer (not shown). Material layer 102 can include soft material. The material layer can be 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, between about 0.01 to about 1.5 mm, between about 1 mm to about 2 mm, between about 0.01 mm to about 2 mm, between about 0.01 to 1 mm, between about 0.01 to about 0.8 mm, between about 0.5 mm to about 0.8 mm, between about 0.8 mm to about 1 mm, between about 0.8 mm to about 2 mm thick, between about 0.8 mm to about 3 mm thick, between about 1.9 mm to about 3 mm thick, or between about 0.01 mm to about 3 mm thick.

In other embodiments, the material layer is less than about 1 mm, less than about 1.5 mm, less than about 2 mm, less than about 3 mm, greater than about 0.5 mm, greater than about 1 mm, greater than about 1.5 mm, between about 0.7 mm to about 1 mm, between about 0.8 mm to 1 mm, or greater than about 2.5 mm thick. In some embodiments, the material layer is less than about 2 mm thick. In other embodiments, the material layer is less than about 3 mm thick. In some embodiments, the material layer is less than 1 mm thick.

It has been determined that in some especially commercially viable embodiments, a thickness of less than about 1 mm for the material layer is preferred.

In some embodiments, the material layer is less than about 2 mm thick in order to prevent peeling and fraying of the material layer. In some embodiments, the material layer is less than about 1 mm thick in order to prevent peeling and fraying of the material layer.

In some embodiments, the assembled construction of the multi-layer plate is less than about 2 mm thick. In other embodiments, the assembled construction of the multi-layer plate is less than about 3 mm thick. In some embodiments, the assembled construction of the multi-layer plate is between about 2 mm to about 3 mm thick. In other embodiments, the assembled construction of at least one multi-layer plate can be 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, between about 1 mm to about 2 mm, between about 1.5 mm to about 2 mm, between about 1.5 mm to about 3 mm, or between about 1.5 to about 2.5 mm thick.

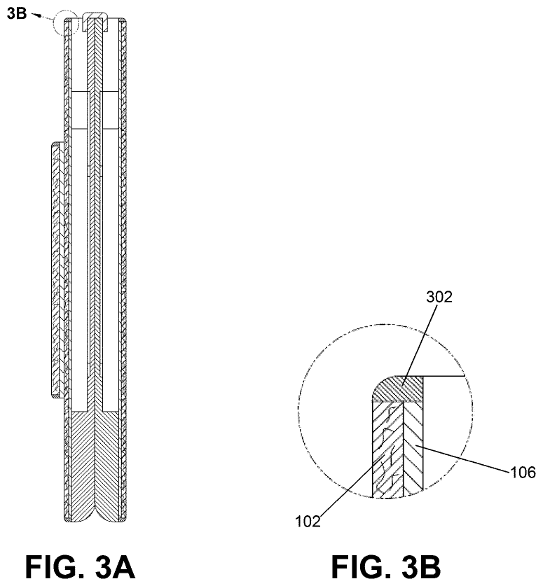

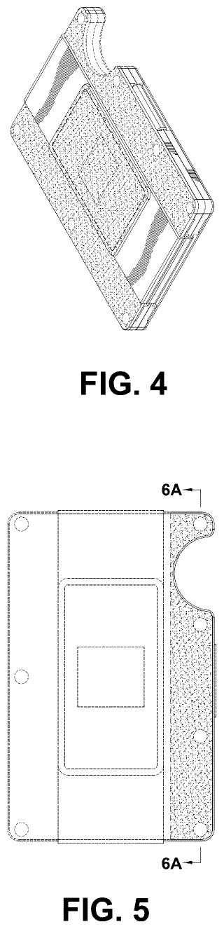

FIG. 3A illustrates a cross section of the wallet shown in FIG. 1 along the arrows labeled 3A. FIG. 3B is a focused view of the circled portion labeled 3B in FIG. 3A. FIG. 3B illustrates that material layer 102 is bonded to substrate layer 106 by the polymeric layer (not shown). As illustrated in FIG. 3B, in some embodiments, the multi-layer plate further includes sealing substance 302. In some embodiments, sealing substance 302 can be a polymer, an oil, an epoxy, a sealant, the like, or a combination thereof. In other embodiments, the sealing substance is an oil.

Substrate layer 106 can include a rigid plate. The rigid plate can include a top edge, a bottom edge, a first side edge, and a second side edge. In some embodiments, the material layer can extend substantially to the top edge of the rigid plate. In other embodiments, the material layer extends substantially to the bottom edge of the rigid plate. In some embodiments, the material layer extends substantially to the first side edge of the rigid plate. In other embodiments, the material layer extends substantially to the second side edge of the rigid plate. The rigid plate is flexible enough to apply the material layer on top, but also sturdy enough to not come undone.

In some embodiments, the material layer substantially covers the entire rigid plate so that the material layer is flush with the rigid plate. Fraying and peeling of the leather can be prevented when the leather is flush with the rigid plate, and less than 1 mm thick. Applicant has found this to be a preferred embodiment given the dimensions of the wallet formed using such plates. This configuration also advantageously permits easy access to the wallet when its being removed from a pocket or bag. In other embodiments, fraying and peeling of the leather can be prevented when the leather is flush with the rigid plate, and less than 2 mm thick.

In other embodiments, the material layer substantially covers the rigid plate but not the entire rigid plate thereby leaving an outer perimeter of the rigid plate without the soft material. As such, the soft material is not flush with the rigid plate at least in some places (e.g., the edges of the rigid plate). In some embodiments, the outer perimeter of the rigid plate can include a sealing substance. The sealing substance can be a polymer, an oil, an epoxy, a sealant, the like, or a combination thereof. In other embodiments, the sealing substance is an oil. The sealing substance can be on the entire outer perimeter of the rigid plate or a portion of the outer perimeter of the rigid plate. In some embodiments, the sealing substance can be on the outer perimeter of the top edge, the first side edge, the second side edge, or the bottom edge of the rigid plate, or a combination thereof. In other embodiments, the sealing substance is on the outer perimeter of top edge, the first side edge, the second side edge, and the bottom edge of the rigid plate.

In some embodiments, as shown in FIG. 1, substrate layer 106 can include finger notch 114. Wallet 100 can be comprised of two rigid plates, which are mirror images of each other. The rigid plates can be held together, i.e. constructed into a wallet configuration, by a plurality of fasteners. In some embodiments, the fasteners are screws or the like.

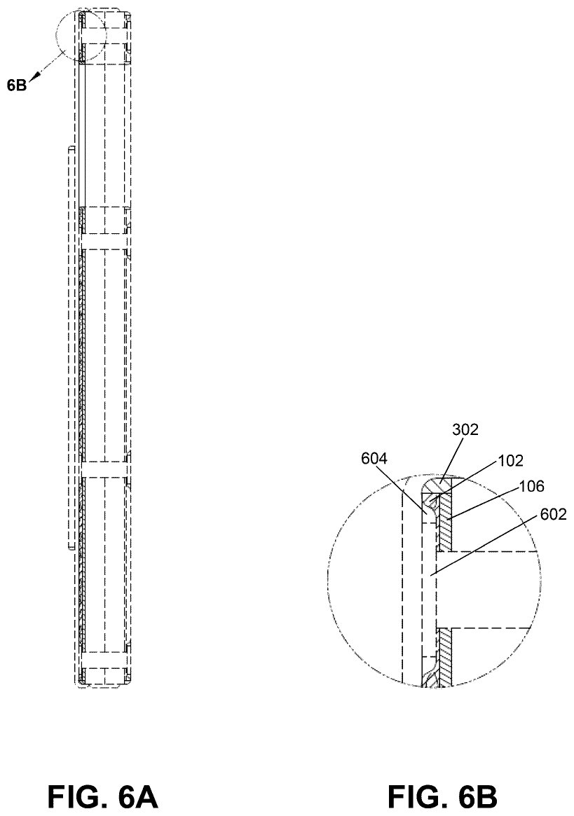

FIG. 6A illustrates a cross section of the wallet shown in FIG. 5 along the arrows labeled 6A. FIG. 6B is a focused view of the circled portion labeled 6B in FIG. 6A. FIG. 6B assists in illustrating how material layer 102 surrounds at least one screw 602, and remains flush with the rigid plate. One of ordinary skill in the art will also appreciate slight pillowing 604 of material layer 102 around at least one screw 602 shown in the focused view of FIG. 6B. In some embodiments, the pillowing of the material layer around at least one screw is negligible. In other embodiments, there is no pillowing of the material layer around at least one screw, particularly when the material layer is relatively thin (e.g., less than 1 mm).

As illustrated in FIG. 1, wallet 100 can further include elastic band 108. The rigid plate can include a channel (not shown) configured to accommodate elastic band 108. Elastic band 108 can include middle portion 110, distal portion 112, and proximal portion 112′. Middle portion 110 can be comprised substantially of leather. Proximal portion 112′ and distal portion 112 can be comprised of a material different from middle portion 110. In some embodiments, proximal, middle, and distal portions of the elastic band can be comprised of the same material. In some embodiments, proximal, middle, and distal portions of the elastic band are entirely comprised of leather. In other embodiments, the elastic band comprises a middle portion made substantially of leather, and proximal and distal portions made substantially of a material different from leather. In some embodiments, the middle portion itself comprises a layered construction involving at least one rigid layer and at least one flexible layer affixed to the rigid layer. The material can be, but is not limited to, those described herein.

In some embodiments, the wallets described herein can further include a money clip. The rigid plate can include a channel configured to accommodate the money clip.

### Example 1

A rigid plate comprised of fiberglass is provided. A suitable piece of leather, i.e. less than 1 mm thick, is bonded to the rigid plate by a glue forming a multi-layer plate. The leather substantially covers the entire rigid plate so that it is flush with the rigid plate.

### Example 2

Two multi-layer plates are prepared as described in Example 1. The two multi-layer plates are then configured into a sandwich like construction and fastened together by at least one screw thereby forming a wallet.

### Example 3

A kit is prepared including the wallet described in Example 2. Also included in the kit are interchangeable accessories, e.g. one or more cash straps and/or money clips, and instructions for use.

### Example 4

A rigid plate comprised of fiberglass is provided. A suitable piece of leather, i.e. less than 1 mm thick, is bonded to the rigid plate by a glue forming a multi-layer plate. The leather substantially covers the rigid plate but not the entire rigid plate thereby leaving an outer perimeter of the rigid plate without leather. The leather is not flush with the rigid plate. The leather is not flush with the rigid plate at least in some places (e.g., the edges of the rigid plate).

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A wallet including:
a multi-layer plate comprising:
a substrate layer,
a polymeric layer, and
a material layer including a soft material, bonded to the substrate layer by the polymeric layer,
wherein the material layer is less than about 1 mm thick.

2. The wallet of claim 1, wherein the substrate layer includes fiberglass.

3. The wallet of claim 1, wherein the polymeric layer is an adhesive.

4. The wallet of claim 1, wherein the soft material is leather.

5. The wallet of claim 4, wherein the leather is natural leather, bonded leather, or synthetic leather.

6. The wallet of claim 1, wherein the substrate layer includes a rigid plate.

7. The wallet of claim 6, wherein the rigid plate includes a top edge, a bottom edge, a first side edge, and a second side edge.

8. The wallet of claim 7, wherein the material layer extends substantially to the top edge of the rigid plate.

9. The wallet of claim 7, wherein the material layer extends substantially to the bottom edge of the rigid plate.

10. The wallet of claim 7, wherein the material layer extends substantially to the first side edge of the rigid plate.

11. The wallet of claim 7, wherein the material layer extends substantially to the second side edge of the rigid plate.

12. The wallet of claim 6, wherein the rigid plate includes a channel configured to accommodate an elastic band.

13. The wallet of claim 6, wherein the rigid plate includes a channel configured to accommodate a money clip.
